(19) United States
(12) Patent Application Publication
(10) Pub. No.: US 2020/0092043 A1
(43) Pub. Date: Mar. 19, 2020

(54) DATA TRANSMISSION METHOD, DEVICE, COMPUTER-READABLE STORAGE MEDIUM, AND SYSTEM

(71) Applicant: SZ DJI TECHNOLOGY CO., LTD., Shenzhen (CN)

(72) Inventors: Bing XUE, Shenzhen (CN); Xiaohu YANG, Shenzhen (CN); Zhongqian YOU, Shenzhen (CN)

(21) Appl. No.: 16/685,237

(22) Filed: Nov. 15, 2019

Related U.S. Application Data
(63) Continuation of application No. PCT/CN2017/084949, filed on May 18, 2017.

(51) Int. Cl. H04L 1/16; H04L 1/00; H04L 1/18; H04L 12/26; H04B 7/185

(52) U.S. Cl. CPC H04L 1/1621; H04L 1/004; H04L 1/0009; H04L 1/1809; H04L 43/0829; H04B 7/18506; H04L 1/1819

(57) ABSTRACT

A data transmission system includes a transmitting device and a receiving device connected by at least two broadcast channels. The transmitting device is configured to encode a data set to be transmitted, the encoded data set includes at least one data group, the at least one data group includes one or more data packets, and the at least two broadcast channels are configured to transmit the one or more data packets. The receiving device is configured to detect the one or more data packets transmitted through the at least two broadcast channels, and when detecting that a data packet has been lost, recover the lost data packet based on one or more other already received data packets included in a same data group as the lost data packet

### CROSS-REFERENCE TO RELATED APPLICATION

This application is a continuation application of International Application No. PCT/CN2017/084949, filed on May 18, 2017, the entire content of which is incorporated herein by reference.

### TECHNICAL FIELD

The present disclosure relates to the technology field of communications and, more particularly, to a data transmission method, a device, a computer-readable storage medium, and a system.

### BACKGROUND

Unicast and broadcast are two communication modes typically used in networks. Unicast is a one-to-one communication mode. After the transmitter transmits data, the transmitter waits for a response from the receiver. If the transmitter does not receive a response from the receiver within a predetermined time period, the transmitter may re-transmit the data until the transmitter receives a response from the receiver. Therefore, unicast can ensure the data can be reliably transmitted. However, when there are multiple receivers that need to receive the same data, the transmitter needs to transmit the same data to the multiple receivers one by one, resulting in a low data transmission efficiency. Broadcast is a one-to-all communication mode. The network may unconditionally copy and forward the data transmitted by the transmitter, such that all of the hosts in the network can receive the data. However, because the transmitter does not wait for a response from the receiver, broadcast cannot ensure the reliability of the data transmission.

In current technologies, to realize reliable data transmission, and to increase the data transmission efficiency, the broadcast communication mode is typically used. In practical applications, the transmitter may encode the data at the physical layer to add the forward error correction redundant data, such that when the receiver loses a portion of the data, the receiver can still recover the data based on the forward error correction redundant data, thereby realizing reliable data transmission.

However, in actual data transmissions, interference is unavoidable. Regardless of the amount of redundant data added, data loss may still be unavoidable.

### SUMMARY

In accordance with an aspect of the present disclosure, there is provided a data transmission system that includes a transmitting device and a receiving device connected by at least two broadcast channels. The transmitting device is configured to encode a data set to be transmitted, the encoded data set includes at least one data group, the at least one data group includes one or more data packets, and the at least two broadcast channels are configured to transmit the one or more data packets. The receiving device is configured to detect the one or more data packets transmitted through the at least two broadcast channels, and when detecting that a data packet has been lost, recover the lost data packet based on one or more other already received data packets included in a same data group as the lost data packet.

In accordance with another aspect of the present disclosure, there is provided a data transmission method. The data transmission method includes detecting data packets transmitted by more than two broadcast channels configured to transmit the same data packets. The data transmission method also includes, based on a detection that a data packet has been lost, recovering the lost data packet based on one or more other already received data packets included in a same data group as the lost data packet.

In accordance with another aspect of the present disclosure, there is provided a data transmission method. The data transmission method includes encoding a data set to be transmitted, where in the encoded data set includes at least one data group, the at least one data group includes one or more data packets. The data transmission method also includes transmitting the one or more data packets through at least two broadcast channels configured to transmit the same data packets.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is an application scene of a data transmission method, according to an example embodiment.

FIG. 2A is a flow chart illustrating a data transmission method, according to an example embodiment.

FIG. 2B is a schematic diagram of an encoded data set, according to an example embodiment.

FIG. 3A is a flow chart illustrating a data transmission method, according to another example embodiment.

FIG. 3B is a schematic diagram of a packet linked list, according to an example embodiment.

FIG. 3C is an illustration of sub-groups of data packets obtained from the packet linked list of FIG. 3B, according to an example embodiment.

FIG. 4 is a data transmission device, according to an example embodiment.

FIG. 5 is a data transmission device, according to another example embodiment.

### DETAILED DESCRIPTION OF THE EMBODIMENTS

Next, the technical solutions of the present disclosure will be described in detail with reference to the accompanying drawings. The described embodiments are only some, but not all of the embodiments of the present disclosure. Based on the described embodiments, a person having ordinary skills in the art can modify or improve the various features of the present disclosure without departing from the principle of the various embodiments disclosed herein and without making creative efforts. Such modification or improvement also fall within the scope of the present disclosure.

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc. The term “processor” may include any suitable processor, which may include hardware, software, or a combination thereof. The processor may be a generic processor or a dedicated processor, which may be specifically programmed to perform certain functions.

A person having ordinary skill in the art can appreciate that when the term “and/or” is used, the term describes a relationship between related items. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. The term “and/or” may be interpreted as “at least one of.”

The present disclosure provides a data communication method. The method may be implemented in an unmanned aerial vehicle (“UAV”) system. The UAV system may include a UAV, an external device (e.g., a cell phone, a remote controller, a remote controller with a screen, a tablet computer, flight glasses, a wristband, a watch, etc.), and more than two broadcast channels (e.g., a wireless fidelity (“WIFI”) channel, a Lightbridge channel). The method may be implemented on the more than two broadcast channels, to realize the communication between the UAV and the external device. For example, the method may be implemented on the more than two broadcast channels to transmit control commands from the external device to the UAV. As another example, the method may be implemented on the more than two broadcast channels to transmit information from the UAV to the external device.

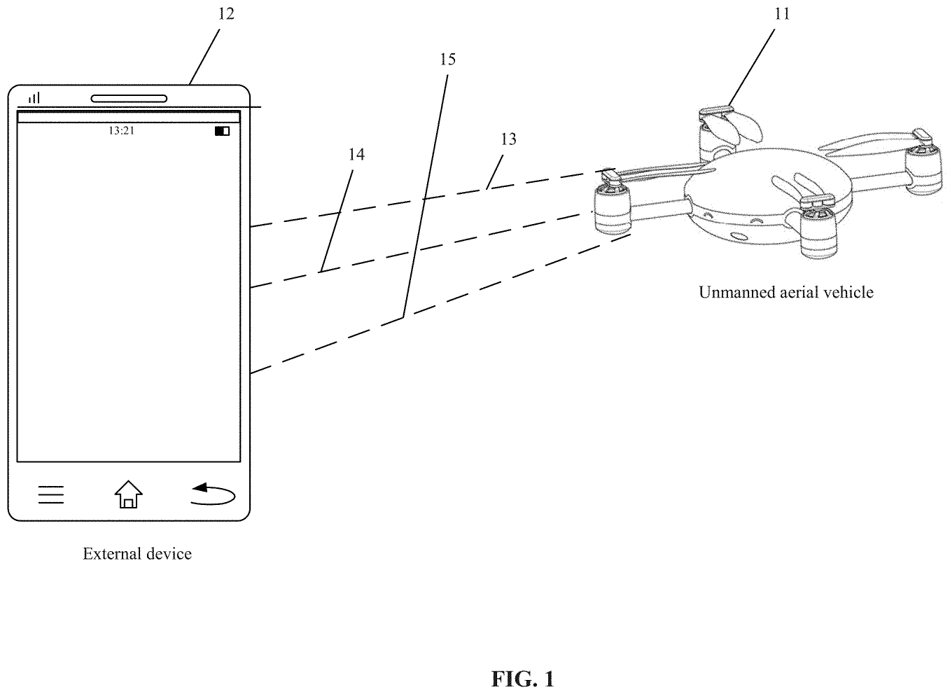

FIG. 1 shows an application scene for realizing the data transmission method. FIG. 1 shows a UAV system that includes a UAV 11, an external device 12, and broadcast channels 13 to 15. Although FIG. 1 only shows a smart cell phone as an example of the external device, in actual applications, the external device 12 may be at least one of a cell phone, a remote controller, a remote controller with a screen, a tablet computer, flight glasses, a wristband, or a watch. In addition, FIG. 1 only shows three broadcast channels as an example. In actual applications, the number of the broadcast channels may be any number over two. The present disclosure does not limit the number of broadcast channels.

As shown in FIG. 1, the data transmission method of the present disclosure may be used to realize the communication between the UAV 11 and the external device 12. Next, with the application scene shown in FIG. 1, the external device 12 as a transmitting device, and the UAV 11 as a receiving device, the data transmission method will be explained from the perspectives of the transmitting device and the receiving device, respectively.

First, the data transmission method is described below from the perspective of the transmitting device:

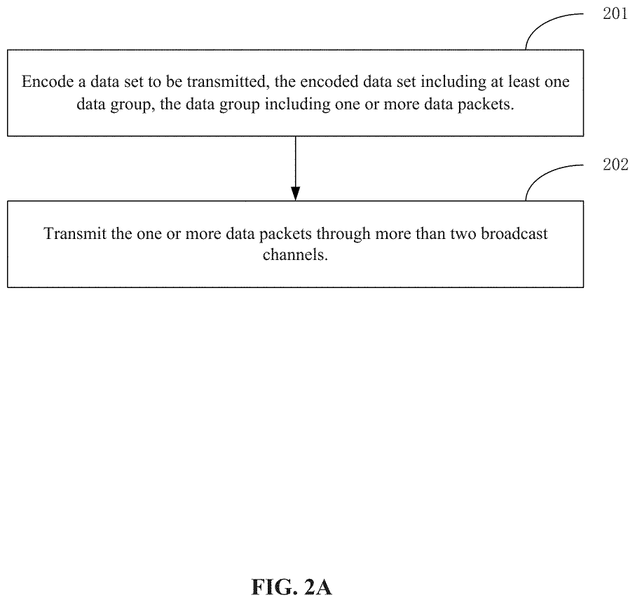

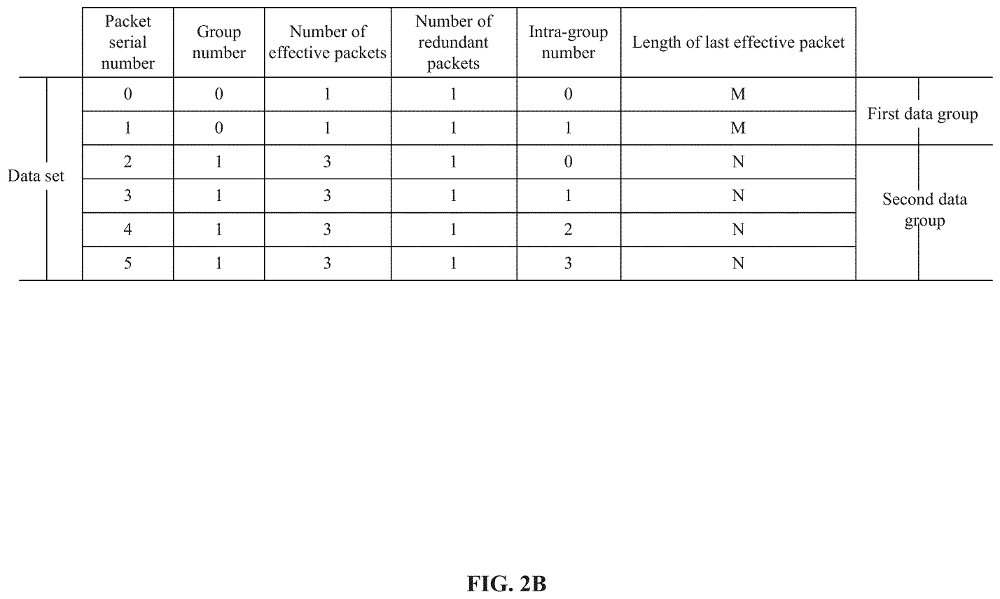

FIG. 2A is a flow chart illustrating a data transmission method. Based on the application scene shown in FIG. 1, the method may be implemented on more than two broadcast channels, such as the broadcast channels 13-15 shown in FIG. 1. The method may include the following steps:

Step 201: encoding a data set to be transmitted, the encoded data set including at least one data group, the data group including one or more data packets.

In some embodiments, the external device 12 may transmit multiple data to the UAV 11. For the convenience of description, these data are referred to as data set to be transmitted. For example, when the external device 12 transmits multiple control commands to the UAV 11, the multiple control commands may be referred to as a data set to be transmitted.

In some embodiments, the external device 12 may first encode the data set to be transmitted, the encoded data set including a data group, and the data group including a data packet.

In some embodiments, the data packet may include an effective packet and a forward error correction redundant packet.

In some embodiments, in a data group, the effective packet may be located before the forward error correction redundant packet.

In some embodiments, the above described data packet may include a packet serial number, a ground number, and an intra-group number.

As described below, the encoding process, the data group, and the data packet of the present disclosure are explained:

Using the data set to be transmitted including two control commands as an example, during the encoding process of the data set, each control command may be divided as a group. That is, the data set to be transmitted may be divided into two sub-groups. Then, the two sub-groups may be each encoded as a group to obtain two data groups. For the convenience of description, the two data groups may be referred to as a first data group and a second data group. Next, using one of the sub-groups, such as the sub-group corresponding to the second data group, as an example, the data in the group may be divided into a number of effective packets having the same length. For example, assuming the length of the data in the sub-group is 6 bytes, and assuming a predetermined length of the effective packet is 2 bytes, then, if the group is divided into an effective packet at every two bytes sequentially, three effective packets may be obtained. Then, based on the forward error correction algorithm, at least one forward error correction redundant packet may be added to the sub-group. The three effective packets and the at least one forward error correction redundant packet may form the second data group.

In some embodiments, the length of the data in the sub-group may not ensure that the data in the sub-group can be divided exactly evenly. For example, when the length of the data of the sub-group is 5 bytes, then, if the group is divided into an effective packet at every two bytes sequentially, the last byte may be divided as an effective packet, to obtain three effective packets.

In some embodiments, for the convenience of subsequent fusion process of the received data packets, the data group of the present disclosure may include a group number. The group number may start from 0 and may gradually increase. For example, the group number of the first data group may be 0, and the group number of the second data group may be 1. The data packets in each data group may have an intra-group number. The intra-group number may start from 0 and may gradually increase. For example, in the above second data group, the 3 effective packets and 1 forward error correction redundant packet may have intra-group number from 0 to 3. Each data packet may carry group information of the data group the data packet belongs to. The group information may include a number of the effective packets in the data group, a number of forward error correction redundant packets, a length of the last effective packet, etc. Each data packet may have a packet serial number, which may start at 0 and may gradually increase. In some embodiments, the packet serial number may correspond to the entire data set to be transmitted. For example, assuming the data set to be transmitted includes the first data group and the second data group, and the first data group includes 2 data packets, and the second data group includes 4 data packets, so there are 6 data packets in total. The packet serial number of the 6 data packets may be 0 to 5 sequentially.

For a person having ordinary skills in the art to clearly understand the encoded data set to be transmitted, FIG. 2B shows an example of the encoded data set.

Step 202: transmitting the one or more data packets through more than two broadcast channels.

In some embodiments, each of the more than two broadcast channels may be a WIFI channel or a Lightbridge channel.

In some embodiments, the external device 12 may add a packet header to the data packets described in step 201 and may verify the data packets. Then the external device 12 may place the data packets in a transmission array in an ascending order of the packet serial numbers (e.g., from small numbers to larger numbers), waiting to be transmitted.

In some embodiments, the external device 12 transmit each of the data packets included in the transmission array through more than two broadcast channels, such as the broadcast channels 13 to 15 shown in FIG. 1. That is, the more than two broadcast channels may be used to transmit the same data packets.

According to the technical solutions of the present disclosure, in this embodiment, the data set to be transmitted may be encoded based on groups. Encoded data set may include a data group. The data group may include a data packet. Each data packet may be transmitted as a unit through more than two broadcast channels. Because the more than two broadcast channels are used to transmit the same data packet, the data transmission reliability may be enhanced using the redundancy of the broadcast channels. In addition, because the encoded data group includes an effective packet and a forward error correction redundant packet, when subsequently the receiving device does not receive the complete data group, the receiving device may recover the lost data packet based on the other data packet(s) included in the data group, thereby enhancing the reliability of the data transmission.

Next, the data transmission method is described below from the perspective of the receiving device:

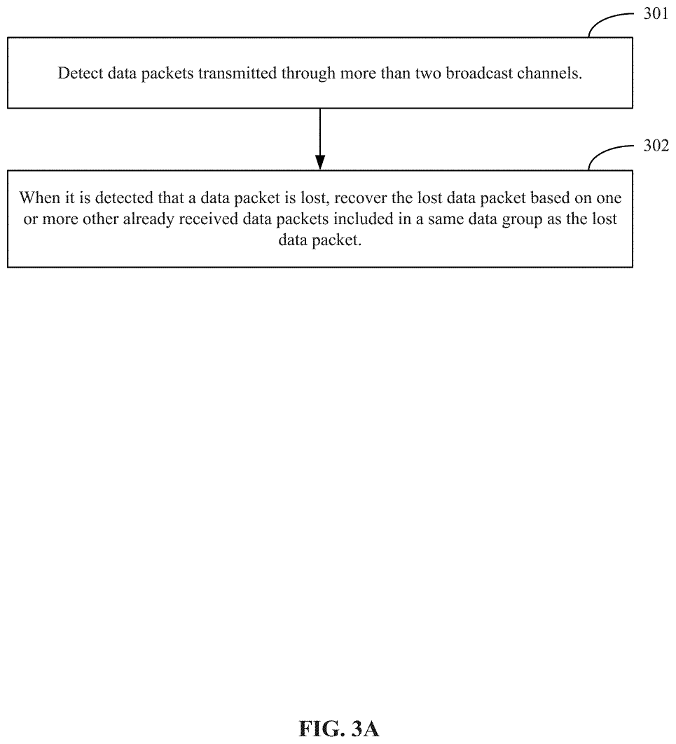

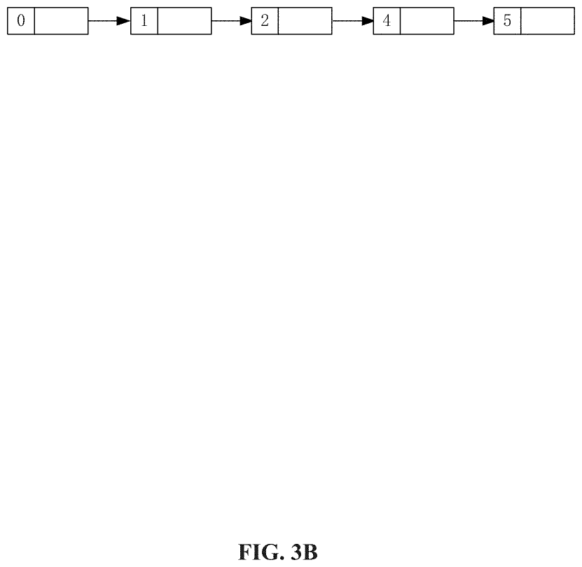

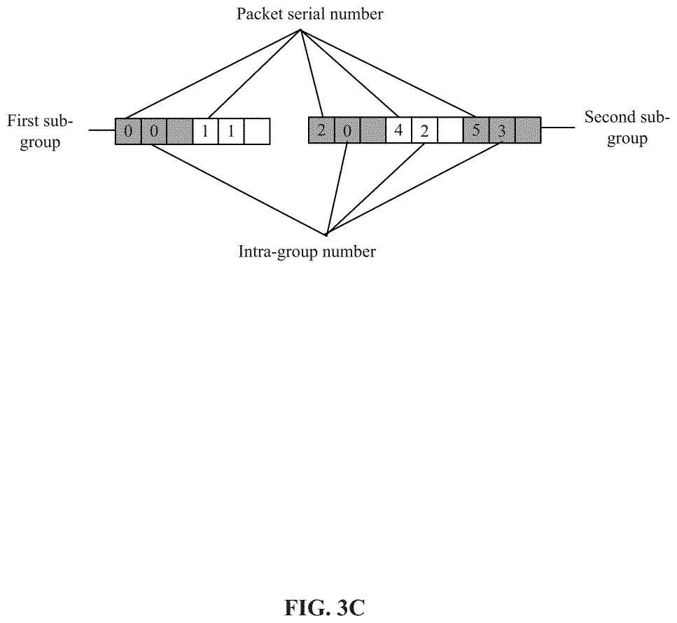

FIG. 3A is a flow chart illustrating a data transmission method. Based on the application scene of FIG. 1 and the data transmission method of FIG. 2, the method of FIG. 3A may be implemented on more than two broadcast channels, such as the broadcast channels 13-15 shown in FIG. 1. The method may include the following steps:

Step 301: detecting data packets transmitted through more than two broadcast channels.

In some embodiments, each of the broadcast channels may be a WIFI channel or a Lightbridge channel.

In some embodiments, the UAV 11 may monitor more than two broadcast channels simultaneously, such as monitoring the broadcast channel 13 to broadcast channel 15 shown in FIG. 1. The UAV 11 may detect a data packet transmitted by the 3 broadcast channels.

In some embodiments, the data packet transmitted by the broadcast channels may include an effective packet and a forward error correction redundant packet. Descriptions of the effective packet and the forward error correction redundant packet may refer to the related descriptions of the embodiment shown in FIG. 2A, which are not repeated.

In some embodiments, when the UAV 11 detects the data packet, the UAV 11 may verify a header of the data packet. Subsequent processing may be performed only on the data packet that has passed the verification.

Step 302: when it is detected that a data packet is lost, recovering the lost data packet based on one or more other already received data packets included in a same data group as the lost data packet.

In some embodiments, when the UAV 11 detects a number of legitimate data packets, i.e., data packets that have passed the verification, the UAV 11 may sort the data packets in an ascending order packet serial numbers (e.g., from smaller numbers to larger numbers). In some embodiments, the data packets may be placed in a packet linked list in the ascending order of the packet serial numbers. FIG. 3B shows an example of a packet linked list. For the purpose of simplicity and illustration, FIG. 3B only shows the packet serial numbers and other components of the data packet are not shown. FIG. 3B only shows an example, which should not limit the data packet of the present disclosure.

In some embodiments, the UAV 11 may divide the detected data packets into sub-groups based on a group number. Further, the UAV 11 may sort the data packets included in each sub-group in an ascending order of intra-group numbers (e.g., from smaller numbers to larger numbers). FIG. 3C shows an example of dividing the data packets into sub-groups based on the packet linked list shown in FIG. 3B. For the purpose of clarity of illustration, FIG. 3C only shows the packet serial number, the intra-group number, and other components of the data packet are not shown. FIG. 3C only shows an example, which should not limit the data packet of the present disclosure.

In some embodiments, after the data packets are sorted in the ascending order of the packet serial numbers (e.g., from smaller numbers to larger numbers), or after the packet linked list of FIG. 3B is obtained, if it is detected that the packet serial numbers are not continuous, as shown in FIG. 3B where the packet serial numbers are not continuous, and if the packet serial number that caused the discontinuity is “3,” then it may be determined tha the data packet corresponding to the packet serial number “3” is lost.

In some embodiments, when it is detected that a data packet is lost, the lost data packet may be recovered based on one or more other already received data packets included in a same data group as the lost data packet. In some embodiments, first the sub-group to which the lost data packet belongs may be determined. If the sub-group satisfies a predetermined forward error correction condition, then the lost data packet may be recovered based on one or more other data packets in the sub-group.

In some embodiments, during the process of determining the sub-group to which the lost data packet belongs, it may be detected whether a sub-group obtained by dividing the above described data packets into sub-groups, such as the sub-group shown in FIG. 3C, satisfies a predetermined first condition. If it is detected that the sub-group satisfies the predetermined first condition, the sub-group may be determined as the sub-group to which the lost data packet belongs.

In some embodiments, the first condition may be the intra-group numbers of the data packets included in the sub-group are not continuous. For example, as shown in FIG. 3C, the intra-group numbers of the data packets in the first sub-group are continuous, and the intra-group numbers of the data packets of the second sub-group are not continuous, then it may be determined that the second sub-group shown in FIG. 3C satisfies the first condition. The second sub-group may be determined as the sub-group to which the lost data packet belongs.

In some embodiments, the above described first condition may be a number of data packets in the sub-group being smaller than an original number of data packets in the sub-group. For example, as shown in FIG. 2B, a number of original effective packets in the second data group corresponding to the second sub-group may be 3, a number of the original forward error correction redundant packets may be 1, i.e., a number of the original data packets in the second data group may be 4. However, the data packet received by the UAV 11 may have a structure shown in FIG. 3C, i.e., in the second sub-group, the number of data packets is 3, smaller than the number of original data packets in the second data group. Then, it may be determined that the second sub-group shown in FIG. 3C satisfies the first condition. The second sub-group may be determined as the sub-group to which the lost data packet belongs.

In some embodiments, the above described forward error correction condition may be: a number of data packets included in a sub-group to which the lost data packet belongs is not smaller than a number of original effective packets included in the sub-group. For example, in FIG. 3C, the number of data packets in the second sub-group may be 3. In addition, FIG. 2B shows that the number of original effective packets included in the second data group corresponding to the second sub-group is 3. Thus, it may be determined that the second sub-group shown in FIG. 3C satisfies the forward error correction condition. Then the lost data packet may be derived based on the data packets included in the second sub-group shown in FIG. 3C based on the forward error correction algorithm.

In some embodiments, because the efficiency of data packet transmission by different broadcast channels may be different, the time instance at which the same data packet is detected in different broadcast channels may be different. In the present disclosure, the lost data packet may be recovered based on data packets transmitted in multiple broadcast channels. For example, when the received data packets are sorted based on the packet serial numbers, and it is determined that the packet serial numbers are not continuous, then the packet serial number of the lost data packet may be determined based on the result of the sorting or based on the packet linked list shown in FIG. 3B, e.g., the packet serial number of the lost data packet may be “3.” For the convenience of description, the packet serial number of the lost data packet may be referred to as a first packet serial number. Subsequently, if the data packet having the first packet serial number is detected in any broadcast channel, this data packet may be used to recover the lost data packet.

In some embodiments, after recovering the lost data packet, the packet serial number of the recovered data packet and the packet serial numbers of other data packets may be sorted in an ascending order of packet serial numbers (e.g., from smaller numbers to larger numbers). Alternatively, the data packet may be inserted into the packet linked list shown in FIG. 3B based on the packet serial number. Through the packet linked list, the efficiency of fusing the data packets by the receiving device may be enhanced.

In some embodiments, the UAV 11 may upload the packet linked list having continuous and complete packet serial numbers from a physical layer of the UAV system to an application layer, until the UAV 11 can completely receive the data set transmitted by the external device 12.

According to the technical solution of the present disclosure, data packets transmitted by two or more broadcast channels may be detected. When it is detected that a data packet has been lost, the lost data packet may be recovered based on one or more other already received data packets included in a same data group as the lost data packet. Because the more than two broadcast channels are used to transmit the same data packets, the data transmission reliability may be enhanced through the redundancy of the broadcast channels. In the meantime, because the lost data packet may be recovered based on other data packets, the data transmission reliability can be enhanced.

In the present disclosure, to avoid waiting for a data packet transmitted by the broadcast channel for long time, which may increase the delay and reduce the efficiency of data transmission, it may be detected whether each broadcast channel satisfies the second condition. When it is detected that the broadcast channel satisfies the second condition, the broadcast channel may be determined as an ineffective broadcast channel, and detection of the data packets on the ineffective broadcast channel may be terminated.

In some embodiments, the second condition may be that the packet serial numbers of the data packets detected on the broadcast channel are all smaller than an expected packet serial number within a predetermined time period. The expected packet serial number may be adjusted based on actually received data packets. For example, if the packet serial number of the currently received data packet is “2,” and the expected packet serial number is “3,” subsequently, when the data packet corresponding to the packet serial number “3” is received, then the “expected packet serial number” may be adjusted to be “4.”

In some embodiments, if within the predetermined time period, the packet serial numbers of the data packets detected on the broadcast channel are all smaller than the current expected packet serial number, then it may be determined that the data transmission efficiency on the broadcast channel is low, and the data transmission delay is relatively long. To avoid affecting the overall data transmission efficiency, the broadcast channel may be set as an ineffective broadcast channel. In the meantime, the detection of the data packets on the ineffective broadcast channel may be terminated.

In some embodiments, after the broadcast channel is set as an ineffective broadcast channel, the UAV 11 may continue to monitor the ineffective broadcast channel. If the packet serial numbers of the data packets monitored on the broadcast channel are not smaller than the current expected packet serial number, the ineffective broadcast channel may be restored as an effective broadcast channel. Subsequently, the data packets transmitted on the broadcast channel may continue to be detected, i.e., the data packets transmitted by the broadcast channel may continue to be fused.

In some embodiments, to avoid losing a data packet in a data group, which may cause the data group to be unrecoverable, the data group may be cleaned up in time to increase the data transmission efficiency. For example, when it is detected that the group numbers of the data packets detected on the more than two broadcast channels are all greater than an expected group number, it may be determined that the data group having the expected group number cannot be restored. The data packets included in the data group may be transferred from the physical layer to the application layer. In the meantime, the current expected group number may be adjusted. For example, the current expected group number may be increased by 1 to obtain a new expected group number.

Based on the same inventive concept as that of the above method, the present disclosure provides a data transmission device.

First, the data transmission device is described from the perspective transmitting device:

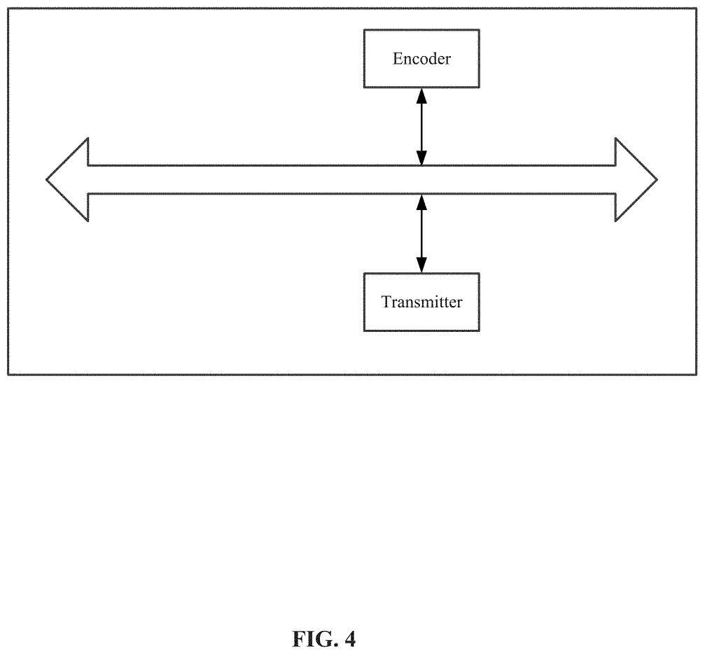

FIG. 4 is a schematic diagram of an example data transmission device. As shown in FIG. 4, the data transmission device may include an encoder and a transmitter. The encoder may be configured to encode the data set to be transmitted. The encoded data set may include one or more data groups. Each data group may include one or more data packets. The transmitter may be configured to transmit the data packets through the more than two broadcast channels.

In some embodiments, the data packet may include: an effective packet and a forward error correction redundant packet.

In some embodiments, the data packet may include a packet serial number, a group number, and an intra-group number.

In some embodiments, in the data group, the effective packet is located before the forward error correction redundant packet.

In some embodiments, the broadcast channel may be a WIFI channel or a Lightbridge channel.

In some embodiments, the data transmission may be implemented in a UAV system. The UAV system may include a UAV and an external device. The data transmission device may be used for the communication between the UAV and the external device.

In some embodiments, the external device may include at least one of: a cell phone, a remote controller, a remote controller with a screen, a tablet computer, flight glasses, a wristband, or a watch.

Next, the data transmission device is described from the perspective of the receiving device:

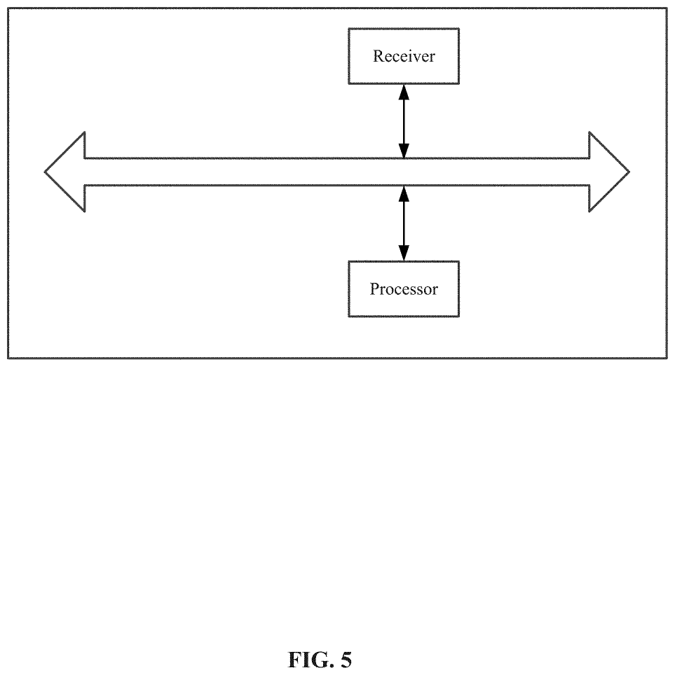

FIG. 5 is a schematic diagram of a data transmission device, according to another example embodiment. As shown in FIG. 5, the data transmission device may include a receiver and a processor. The receiver may be configured to detect data packets transmitted by more than two broadcast channels. The processor may be configured to detect that a data packet is lost, and recover the lost data packet based on one or more other already received data packets included in a same data group as the lost data packet.

In some embodiments, the processor may be configured to: sort data packets detected on more than two broadcast channels in an ascending order of the packet serial numbers (e.g., from smaller numbers to larger numbers); and determine that a data packet is lost when it detects that the packet serial numbers are not continuous.

In some embodiments, the data packet may include: an effective packet and a forward error correction redundant packet.

In some embodiments, the processor may be configured to divide the received data packets into sub-groups based on a group number; determine a sub-group to which the lost data packet belongs; and if the sub-group to which the lost data packet belongs satisfies a predetermined forward error correction condition, recover the lost data packet based on one or more other data packets included in the sub-group to which the lost data packet belongs.

In some embodiments, the processor may be configured to: if the sub-group satisfies a predetermined first condition, determine that the sub-group is the sub-group to which the lost data packet belongs.

In some embodiments, the first condition may be: the intra-group numbers of the data packets included in the sub-group are not continuous.

In some embodiments, the first condition may be: a number of data packets in the sub-group is smaller than a number of original data packets included in the sub-group.

In some embodiments, the predetermined forward error correction condition may be: a number of data packets included in the sub-group to which the lost data belongs is not smaller than a number of original effective packets included in the sub-group to which the lost data packet belongs.

In some embodiments, the processor may be configured to: based on a shorting result, determine a first packet serial number of the lost data packet; when a data packet having the first packet serial number is detected on any broadcast channel, recover the lost data packet based on the data packet having the first packet serial number.

In some embodiments, the processor may be configured to: if the broadcast channel satisfies a predetermined second condition, determine the broadcast channel as an ineffective broadcast channel; and terminating the detection of the data packets transmitted by the ineffective broadcast channel.

In some embodiments, the second condition may be: the packet serial numbers of the data packets detected on the broadcast channels within a predetermined time period are all smaller than an expected packet serial number.

In some embodiments, the processor may be configured to: when the group numbers of the data packets detected from the more tha two broadcast channels are all greater than a predetermined expected group number, adjust the expected group number.

In some embodiments, the broadcast channel is a WIFI channel or a Lightbridge channel.

In some embodiments, the data transmission device may be implemented in a UAV system. The UAV system may include a UAV and an external device. The data transmission device may be used for the communication between the UAV and the external device.

In some embodiments, the external device may include at least one of: a cell phone, a remote controller, a remote controller with a screen, a tablet computer, flight glasses, a wristband, or a watch.

Based on the same inventive concept as that of the above method, the present disclosure also provides a non-transitory computer-readable storage medium.

First, the computer-readable storage medium is described from a perspective of the transmitting device:

The computer-readable storage medium may be used in the transmitting device. Computer instructions may be stored in the computer-readable storage medium. When the computer instructions are executed by a processor, the computer instructions may cause the processor to perform a method including the following: encoding a data set to be transmitted, the encoded data set including a data group, the data group including a data packet; and transmitting the data packet through more than two broadcast channels.

In some embodiments, the data packet may include: an effective packet and a forward error correction redundant packet.

In some embodiments, the data packet may include a packet serial number, a group number, and an intra-group number.

In some embodiments, in the data group, the effective packet may be located before the forward error correction redundant packet.

In some embodiments, the broadcast channel may be a WIFI channel or a Lightbridge channel.

In some embodiments, the computer-readable storage medium may be used in a UAV system. The UAV system may include a UAV and an external device. The computer-readable storage medium may be used for the communication between the UAV and the external device.

In some embodiments, the external device may include at least one of: a cell phone, a remote controller, a remote controller with a screen, a tablet computer, flight glasses, a wristband, or a watch.

Next, the computer-readable storage medium is described from a perspective of the receiving device:

The computer-readable storage medium may be used in a receiving device. Computer instructions may be stored in the computer-readable storage medium. When the computer instructions are executed by a processor, the computer instructions may cause the processor to perform a method including: detecting data packets transmitted by more than two broadcast channels; when it is detected that a data packet is lost, recovering the lost data packet based on one or more other already received data packets included in a same data group as the lost data packet.

In some embodiments, during the process of detecting that a data packet is lost, when the computer instructions are executed by the processor, the computer instructions may cause the processor to perform the following processes: sorting data packets detected from the more than two broadcast channels in an ascending order of packet serial numbers (e.g., from smaller numbers to larger numbers); and determining that a data packet is lost when it is detected that the packet serial numbers are not continuous.

In some embodiments, the data packet may include: an effective packet and a forward error correction redundant packet.

In some embodiments, during the process of recovering the lost data packet based on already received one or more other already received data packets included in a same data group as the lost data packet, when the computer instructions are executed by the processor, the computer instructions may cause the processor to perform the following processes: dividing the received data packets into sub-groups based on a group number; determining a sub-group to which the lost data packet belongs; if the sub-group to which the lost data packet belongs satisfies a predetermined forward error correction condition, recovering the lost data based on one or more other data packets included in the sub-group to which the lost data packet belongs.

In some embodiments, during the process of determining the sub-group to which the lost data packet belongs, the computer instructions may be executed by the processor to perform the following process: if it is detected that the sub-group satisfies the first condition, determining that the sub-group is the sub-group to which the lost data packet belongs.

In some embodiments, the first condition may be: the intra-group numbers of the data packets in the sub-group are not continuous.

In some embodiments, the first condition may be: the number of data packets included in the sub-group is smaller than the number of original data packets included in the sub-group.

In some embodiments, the predetermined forward error correction condition may be: the number of data packets included in the sub-group to which the lost data packet belongs is not smaller than the number of original effective packets included in the sub-group to which the lost data packet belongs.

In some embodiments, when the computer instructions are executed by the processor, the computer instructions may cause the processor to perform the following processes: determining a first packet serial number of the lost data packet based on a sorting result; when a data packet having the first packet serial number is detected by any broadcast channel, recovering the lost data packet based on the data packet having the first packet serial number.

In some embodiments, when the computer instructions are executed by the processor, the computer instructions may cause the processor to perform the following processes: if the broadcast channel satisfies a predetermined second condition, determining the broadcast channel as an ineffective broadcast channel; and terminating the detection of the data packets transmitted by the ineffective broadcast channel.

In some embodiments, the second condition may be: the packet serial numbers of the data packets detected from the broadcast channels within a predetermined time period are all smaller than an expected packet serial number.

In some embodiments, when the computer instructions are executed by the processor, the computer instructions may cause the processor to perform the following processes: when the group numbers of the data packets detected from the more than two broadcast channels are all greater than a predetermined expected group number, adjusting the expected group number.

In some embodiments, the broadcast channel is a WIFI channel or a Lightbridge channel.

In some embodiments, the computer-readable storage medium may be used in a UAV system. The UAV system may include a UAV and an external device. The computer-readable storage medium may be used for the communication between the UAV and the external device.

In some embodiments, the external device may include at least one of: a cell phone, a remote controller, a remote controller with a screen, a tablet computer, flight glasses, a wristband, or a watch.

Based on the same inventive concept as that of the method, the present disclosure also provides a data transmission system. The system may include a transmitting device and a receiving device. There are at least two broadcast channels between the transmitting device and the receiving device. In the data transmission system:

The transmitting device is configured to encode a data set to be transmitted, the encoded data set including a data group, the data group including a data packet; and transmitting the data packet through the more than two broadcast channels.

The receiving device is configured to detect the data packets transmitted through the more than two broadcast channels; when it is detected that a data packet is lost, recovering the lost data packet based on one or more other already received data packets included in a same data group as the lost data packet.

In some embodiments, the broadcast channel is a WIFI channel or a Lightbridge channel.

In some embodiments, the data transmission system may be used in a UAV system. The UAV system may include a UAV and an external device. The data transmission system may be used for the communication between the UAV and the external device.

In some embodiments, the receiving device is the UAV, and the transmitting device is the external device. Alternatively, the receiving device is the external device, and the transmitting device is the UAV.

In some embodiments, the external device may include at least one of: a cell phone, a remote controller, a remote controller with a screen, a tablet computer, flight glasses, a wristband, or a watch.

The system, device, module or unit described in the above embodiments may be realized using a computer chip or a physical entity, or a product having certain functions. A typical realization device is a computer. The detailed form of the computer may be a personal computer, a laptop computer, a cellular phone, a camera phone, a smart phone, a personal digital assistant, a multimedia player, a navigation device, an e-mail receiving and transmitting device, a game control console, a tablet computer, a wearable device, or any combination of two or more of these devices.

For the convenience of descriptions, the above devices are described based on functions being divided as various units. When implementing the present disclosure, functions of various units may be realized in one or multiple software programs and/or hardware components.

A person having ordinary skills in the art can appreciate, the present disclosure may be realized as a method, a system, or a computer program product. As such, the present disclosure may be realized using hardware alone, software alone, or a combination of software and hardware. In addition, the present disclosure may be realized as a computer program product implemented in one or more computer-readable storage media (including but not limited to a magnetic disk, a CD-ROM, an optical device, etc.) that store computer-executable program codes or instructions.

The present disclosure is described with reference to the flow charts and/or block diagrams of the disclosed methods, devices (systems), and computer program products. It should be understood that computer program codes or instructions may be used to realize each step and/or block included in the flow chart and/or block diagram, and a combination of the steps and/or blocks in the flow chart and/or the block diagram. Such computer program codes or instructions may be provided to a generic computer, a dedicated computer, an embedded processor, or a processor of a programmable data processing device to generate a machine, such that a device may be produced through the instructions executed by the computer or other processor of a programmable data processing device. The device may be used to realize a specified function of one or more steps in the flow chart and/or one or more blocks in the block diagram.

In addition, the computer program codes or instructions may be stored in a computer-readable storage medium that may guide a computer or other programmable data processing device to operate in a specified manner, such that instructions stored in the computer-readable storage medium generate a product having an instruction device. The instruction device may realize a specific function of one or more steps in the flow chart and/or one or more blocks of the block diagram.

The computer program codes or instructions may be loaded into a computer or other programmable data processing device, such that a series of steps may be executed on the computer or other programmable data processing device to generate a computer-realized process, such that the codes executed by the computer or other programmable data processing device may provide a step for realizing a specific function of one or more steps of the flow chart and/or one or more blocks of the block diagram.

A person having ordinary skills in the art can appreciate, the embodiments of the present disclosure may be provided as methods, systems, or computer program products. As such, the present disclosure may be implemented in the forms of hardware alone embodiments, software alone embodiments, or embodiments combining software and hardware. In addition, the present disclosure may be implemented as a computer program product that may be implemented in one or more computer-readable storage media (including but not limited to a magnetic disk, a CD-ROM, an optical storage device, etc.) that include computer-executable program codes or instructions.

The above described are only embodiments of the present disclosure, and are not intended to limit the scope of the present disclosure. A person having ordinary skills in the art can modify or change the embodiments of the present disclosure. Such modifications, equivalent substitutions, or improvements within the spirit and principle of the present disclosure all fall within the scope of the claims of the present disclosure.

What is claimed is:

1. A data transmission system, comprising:
a transmitting device and a receiving device connected by at least two broadcast channels,
wherein the transmitting device is configured to encode a data set to be transmitted, the encoded data set includes at least one data group, the at least one data group includes one or more data packets, and wherein the transmitting device is configured to transmit the one or more data packets through the at least two broadcast channels, and
wherein the receiving device is configured to detect the one or more data packets transmitted through the at least two broadcast channels, and when detecting that a data packet has been lost, recover the lost data packet based on one or more other already received data packets included in a same data group as the lost data packet.

2. The data transmission system of claim 1,
wherein the system is implemented in an unmanned aerial vehicle (“UAV”) system, the UAV system includes a UAV and an external device, and the system is configured for communication between the UAV and the external device, and
wherein the receiving device is the UAV and the transmitting device is the external device, or the receiving device is the external device and the transmitting device is the UAV.

3. The data transmission system of claim 2, wherein the external device includes at least one of: a cell phone, a remote controller, a remote controller having a screen, a tablet, flight glasses, a wristband, or a watch.

4. A data transmission method, comprising:
detecting data packets transmitted by more than two broadcast channels configured to transmit the same data packets; and
based on a detection that a data packet has been lost, recovering the lost data packet based on one or more other already received data packets included in a same data group as the lost data packet.

5. The data transmission method of claim 4, wherein detecting that a data packet has been lost comprises:
sorting the data packets detected from the more than two broadcast channels according to an ascending order of packet serial numbers; and
determining that a data packet has been lost based on a detection that the packet serial numbers are not continuous.

6. The data transmission method of claim 4, wherein the data packet comprises an effective packet and a forward error correction redundant packet.

7. The data transmission method of claim 6, wherein recovering the lost data packet based on one or more other already received data packets included in a same data group as the lost data packet comprises:
dividing already received data packets into sub-groups based on group numbers;
determining a sub-group to which the lost data packet belongs; and
based on a determination that the sub-group to which the lost data packet belongs satisfies a predetermined forward error correction condition, recovering the lost data packet based on the one or more other already received data packets included in the sub-group to which the lost data packet belongs.

8. The data transmission method of claim 7, wherein determining the sub-group to which the lost data packet belongs comprises:
based on a detection that a sub-group satisfies a predetermined first condition, determining the sub-group that satisfies the predetermined first condition as the sub-group to which the lost data packet belongs.

9. The data transmission method of claim 8,
wherein the predetermined first condition is intra-group numbers of data packets included in the sub-group are not continuous, or
wherein the predetermined first condition is a number of data packets included in the sub-group is smaller than a number of original data packets included in the sub-group.

10. The data transmission method of claim 7, wherein the predetermined forward error correction condition is:
a number of data packets included in the sub-group to which the lost data packet belongs is not smaller than a number of original effective packets included in the sub-group to which the lost data packet belongs.

11. The data transmission method of claim 5, further comprising:
determining a first packet serial number of the lost data packet based on a sorting result; and
when a data packet having the first packet serial number is detected from one of the more than two broadcast channels, recovering the lost data packet based on the data packet having the first packet serial number.

12. The data transmission method of claim 4, further comprising:
when a broadcast channel of the more than two broadcast channels satisfies a predetermined second condition, determining the broadcast channel as an ineffective broadcast channel; and
terminating detection of data packets transmitted through the ineffective broadcast channel.

13. The data transmission method of claim 12, wherein predetermined second condition is:
packet serial numbers of data packets detected from the broadcast channel within a predetermined time period are all smaller than an expected packet serial number.

14. The data transmission method of claim 4, further comprising:
when group numbers of data packets detected from the more than two broadcast channels are all greater than a predetermined expected group number, adjusting the expected group number.

15. The data transmission method of claim 4, wherein at least one of the more than two broadcast channels is a WIFI channel.

16. A data transmission method, comprising:
encoding a data set to be transmitted, where in the encoded data set includes at least one data group, the at least one data group includes one or more data packets; and
transmitting the one or more data packets through at least two broadcast channels configured to transmit the same data packets.

17. The data transmission method of claim 16, wherein the one or more data packets include at least one of an effective packet and a forward error correction redundant packet.

18. The data transmission method of claim 16, wherein the one or more data packets include at least one of a packet serial number, a ground number, or an intra-group number.

19. The data transmission method of claim 17, wherein in the one or more data packets, wherein the effective packet is located before the forward error correction redundant packet.

20. The data transmission method of claim 16, wherein the at least two broadcast channels are WIFI channels.
